(19) United States
(12) Patent Application Publication
(10) Pub. No.: US 2019/0066487 A1
(43) Pub. Date: Feb. 28, 2019

(54) NOTIFICATION DEVICE

(71) Applicant: ATEIS MIDDLE EAST FZCO, Dubai (AE)

(72) Inventor: Haider Al Haddad, Abu Dhabi (AE)

(73) Assignee: ATEIS MIDDLE EAST FZCO, Dubai (AE)

(21) Appl. No.: 16/080,544

(22) PCT Filed: Feb. 22, 2017
(86) PCT No.: PCT/IB2017/050991

§ 371 Date: Aug. 28, 2018

(30) Foreign Application Priority Data
Mar. 1, 2016 (EP) 16158130.1

(51) Int. Cl. G08B 29/18

(52) U.S. Cl. CPC G08B 29/181

(57) ABSTRACT

The invention relates to a notification device, comprising a main processing unit (40), at least a signaling sub-system (60, 70), a power supply sub-system (30), an interface to a control and power circuit and an energy storage sub-system (20), wherein the notification device is adapted to receive commands and energy from a central control panel via the control and power circuit. In order to increase efficiency the energy storage sub-system (20) operates with low voltage.

The invention relates to a notification device according to the preamble of claim 1.

Such notification device comprises a main processing unit, at least a signalling sub-system, a power supply sub-system, an interface to a control and power circuit and an energy storage sub-system, wherein the notification device is adapted to receive commands and energy from a central control panel via the control and power circuit.

Notification devices used in life safety and mass notification systems such as in fire alarm or security alert or military warning devices are designed to alert personnel, operators, residents of a possible life safety threat, hazardous situation, fire, smoke, attack, . . . etc. The methods of alerting the public or individuals are usually through audible signals or recorded/live messages. Disabled sector of the public which have hearing impairment condition should be warned by visual signaling such as but not limited to flashing lights, text displayed messages or combination of both light and text displayed messages.

The significance of the alerting system is to stay functional as long as possible and cover the entire occupied area designed for the public use, this is normally achieved by connecting the notification appliance to a main or central control panel through a control and power circuit (“CPC”) that will provide power supply as well as a sort of command and instruction to the notification appliance/s in a single or plural formation, in a star or ring topology, these systems normally uses a pair of wires that deliver both the power and signaling on one circuit or use multiple pairs of wires to achieve the same goal.

In case the notification device is disconnected from the CPC, then the device will be disabled and rendered useless and isolated.

In order to avoid this problem the notification appliance should stay signaling from 35 to 60 minutes even after it is disconnected from the CPC by using an energy storage device as the primary source of power in all conditions.

There are various kinds and types of notification systems and devices, all available systems depends on the control and power circuit to provide power and control instructions to the appliance to activate and provide power excluding the battery powered wireless communicated devices. When the device is disconnected from the CPC it will be powered down and will go in the non-functional state.

Other systems exist that utilizes energy storage devices that charges during system idle times and/or non-alarm states to high voltage levels to reduce the current drawn by the appliance through the CPC 2 due to their use of high power indicating or signaling devices like light discharge tubes or high power LED/s or high power non efficient audio signaling devices.

In WO 2013/081773 A a notification device is disclosed which comprises an energy storage device so that offline operation is possible for some time. The energy storage device is a supercapacitor operated with high voltage of 300 V to 400 V. Therefore the voltage has to be reduced for driving the microcontroller. Due to energy loss the offline operation is limited to about 5 minutes. The size of the energy storing device is impractically large given that each cell typically has a voltage limit of less than 3 V. Therefore at least 100 cells would be necessary for achieving a voltage of 300 V, rendering it impractical as of to date available technology.

It is an object of the invention to enhance the ability of the notification device to operate in an autonomous state. None of the above existing systems is able to prolong the consistent operation of the device with or without connection to the CPC after the initiation of the alarm command for a period as long as 35 to 60 minutes of continuous operation at the same level of indication output whether light levels or audio levels.

It is a further object of the notification device to use the low voltage storage device to power its subsystems to a small low voltage level as mentioned earlier and in the claim and when energized fully it can stand autonomous after receiving the alarm command from the CPC to stay activated for a period of 35-60 minutes.

The above objects are achieved according to claim 1 in that the energy storage sub-system operates with low voltage. Surprisingly the duration of operation in offline mode can be extended considerably in that way. Low voltage means considerably smaller than voltage of line current, namely a voltage which can be used directly to drive electronic circuits or devices. Typically it lies within a range between 3 V and 24 V, preferably between 5 V and 12 V.

The Detachable notification Device (“DND”) that is disclosed, in an embodiment is a device that is used singular or plural in a notification system such as but not limited to, fire alarm system, mass notification system, military alarm systems, annunciator systems, voice evacuation systems. The DND receives its command instruction/s from the central control panel through two wire communication system to activate or deactivate the indicating output.

Output indication is in the form of visual such as but not limited to pulsed light flashes, text messages, audio signals of stored message nature or audio tones or combination.

The DND is initially powered by the control and power circuit (CPC), it will charge and accumulate energy in the form of low voltage energy not exceeding 6 volts.

The DND depends on its internal low voltage high energy storage device/s for its operation while is connected to the control and power circuit (CPC), DND will receive the commands from the central control panel through CPC. In the event or alarm or indication is requested by the central control panel, the DND will trigger the indicting output device through the microprocessor to activate the output type as designed, in an embodiment pulsating light flashes, audio tones, audio messages, display text message or any combination of the output type.

During the alarm state the DND and in the event of the device is isolated or detached from the control and power circuit (CPC) the device will continue its state without interruption and will return to its idle state after a period from 35 to 60 minutes of continuous output state without reducing the output signaling level.

In the event that the system can recover to its initial state and still the DND device is detached, then it will be indicated on the system's central control panel that a DND is missing or detached, at the same time the DND contains a status indicator light which will indicate that the DND is in detached mode and attention will be required to return the DND to its original state.

Preferably the system is feeding back the excess energy from the output stage back to the low voltage high energy storage device/s, whether it was connected to the Control and Power Circuit (CPC) or disconnected from the (CPC) using the charge recovery technique, in which any stored energy in the output stage is redirected towards the storage device through microprocessor controlled MOSFET acting in a switching configuration and through a specific control feedback control cycle by cycle of the output stage.

The operation of the DND is based on utilizing of low voltage storage devices, and supplying its subsystems with low voltage supply derived from the storage device to feed to its parts and minimizing the losses during the conversion stages, also in an embodiment the device utilizes energy recovery by back feeding the extra power contained in the output device back to its low voltage high energy storage device/s through a microprocessor controlled feedback path to extend the operation time and increase the overall DND device efficiency.

Now the present invention is explained with reference to the enclosed drawing.

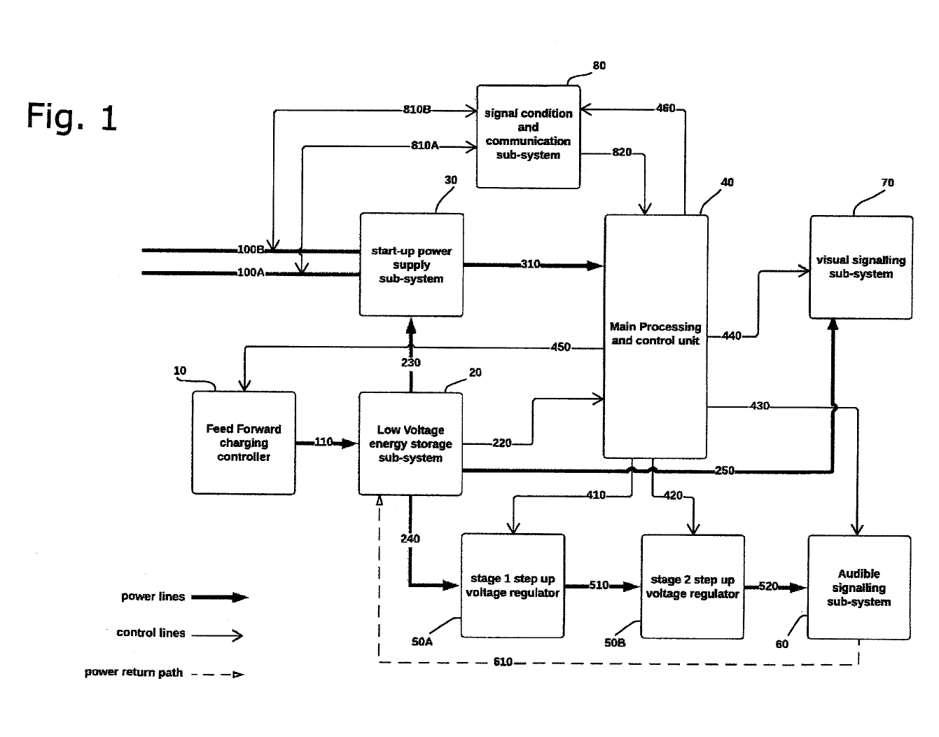

FIG. 1 is a diagram showing a preferred embodiment of the invention.

The following is a functional description of the invention, refer to FIG. 1 where the system is comprised of the following:
10: Feed forward charging controller, this will charge the main storage unit until 5.4 V DC and maintain the charge voltage constant, it is enabled by 40 (main processing and control unit) but its self-controlled, where it controls the charging process in at constant power, hence the input power to the device is maintained constant.
20: Low voltage energy storage sub-system, this is the main energy storage device, can be a supercapacitor or a bank of supercapacitors or ay storage element that can act in a charging and discharging pattern. It will hold low voltage high energy of up to 5.4 Volts DC and of energy start from 729 Joule up to 1600 Joule. It will feed act as power reserve for the system and supply all its sub-systems during operation. It is monitored by 40 (main processing and control unit) to measure its voltage level and health status, in case of fault it will indicate to the main CPC that this device is in a fault condition.
30: Start up power supply sub-system, this will supply 40 (main processing and control unit) during startup of the system and can fold back to 30 (Low voltage energy storage sub-system) at any time during the operation in the normal state or even during the alarm state.
40: Main processing and control unit, this is either a low power micro controller with inbuilt memory structure of flash memory and RAM, or at another instance can be a central processing unit with external flash memory and external RAM. Its operation and function is the control, signaling and supervision of all functions of the device, it controls 50A &50B sub-systems to enable the voltage step up to power up (60 audible signaling sub-system) through signals 410, 420. It produces the pattern for the audible signal of sub-system 60 through 430 and controls the function of this sub-system. It controls (70 visual signaling sub-system) through 440, it produces the visual pattern signals, enable the sub-system and controls the visual pulse duration. This sub-system interacts with 80 (signal conditioning and communication sub-system) through lines 820 and 460 to send and receive commands and answers to the CPC and from the CPC through sub-system 80. It measures the voltage and energy levels of sub-system 20 through line 220 which will indicate the status of the energy levels and if any fault in the energy storage exists. It enables and disables the function of sub-system 10 which controls the charging process through 450. The startup power for this sub-system is supplied from sub-system 30 where it filters the line voltage and generates a regulated and noise free 3.3 Volt DC to supply to 40 through 310.
50A: stage 1 step-up voltage regulator, this is a regulating switching power supply sub-system to control the input of 50B to be at 3.3 Volt DC all the time, since the voltage levels of 20 can change from 5.4 V to 1.8 V through energy depletion due to consumption by other sub-systems mainly 70 and 60 during alarm condition, this is controlled and enabled by sub-system 40 through 410.
50B: stage 2 step-up voltage regulator, this is the final stage of voltage conversion from 3.3 V supplied by 50A up to the level required by sub-system 60 which is between 19-28 V DC, the voltage level is controlled by sub-system 40 through 420.
60: Audible signaling sub-system, this sub-system is responsible to produce the audible alarm signal in the form of tones or in an embodiment broadcasting recorded messages. The sub-system will take its power from 50B where the level is set by sub-system 40, the signal type and pattern is generated by sub-system 40 and transmitted to this sub-system through 430. It comprises of signal transducer which is not the subject of this document and driving circuit that will recover part of the energy used to drive the transducer bask to the sub-system 20 through 610, which will enable the use of residual energy in the audio transducer to be utilized by the other sub-systems that will increase the overall system efficiency in which microprocessor controlled switching circuitry will reverse the voltage polarity and current direction of the excess energy available in the output stage and redirect it towards the storage device, hence the unit will increase the overall system efficiency.
70: visual signaling sub-system, this is the stage where the generation of the visual signal in the form of flashing pulses of light or text messages displayed through light emitting diodes (LED) of high efficiency and high watt/lumens output takes place. This is controlled by sub-system 40 and powered directly from sub-system 20 through 440 and 250 respectively. This sub-system can either exist or be removed depending on the type of the DND, in case of only visual DND then only this sub-system exist and sub-system 60 is removed, in another embodiment or version of DND sub-system can exist and sub-system 70 is removed resulting in an audio signaling and notification device and another version where both sub-systems exist will result in a audio visual DND, regardless of which sub-system exists the remaining sub-systems are unaffected and the concept of the subject DND remains the same.
80: signal conditioning and communication sub-system, this is the last sub-system in the DND, it is responsible to filter, condition and prepare the line signal from CPC to be interfaced to sub-system 40 with isolation capabilities in case of external conditions exerted on the line that can endanger and compromise the performance of the DND, this sub-system send the instructions received though CPC from the central control panel to sub-system 40 through 820 and transmits the answer (if required) to the central control panel through the CPC via 460 after reconditioning to follow the protocol of communication.

1. A notification device, comprising a main processing unit, at least a signalling sub-system, a power supply sub-system, an interface to a control and power circuit and an energy storage sub-system, wherein the notification device is adapted to receive commands and energy from a central control panel via the control and power circuit, wherein the energy storage sub-system operates with low voltage.

2. The notification device according to claim 1, wherein the energy storage sub-system comprises at least one supercapacitor.

3. The notification device according to claim 1, wherein the low voltage of the energy storage sub-system is in a range between 3 V and 24 V, preferably between 5 V and 12 V.

4. The notification device according to claim 1, wherein a feedback-circuit is provided for feeding back energy from the signalling sub-system to the power supply sub-system or the energy storage sub-system.

5. The notification device according to claim 1, wherein the signalling sub-system comprises a visual signalling sub-system.

6. The notification device according to claim 1, wherein the signalling sub-system comprises an audible signalling sub-system.

7. The notification device according to claim 1, wherein the power supply sub-system comprises a start-up power supply sub-system.
